(19) United States
(12) Patent Application Publication
(10) Pub. No.: US 2011/0004690 A1
(43) Pub. Date: Jan. 6, 2011

(54) Method of Forwarding Messages Over a Network and System for Implementing the Method

(75) Inventors: Dominique Georgel, Taverny (FR); Laurent Iozelli, Paris (FR); Vivien Emiya, Paris (FR); Florian Ponroy, Paris (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: THALES, Neuilly-sur-Seine (FR)

(21) Appl. No.: 12/746,162

(22) PCT Filed: Dec. 3, 2008
(86) PCT No.: PCT/EP08/66735

§ 371 Date: Sep. 13, 2010

(30) Foreign Application Priority Data
Dec. 4, 2007 (FR) 0708456

(51) Int. Cl. G06F 15/16

(52) U.S. Cl. 709/227; 709/240

(57) ABSTRACT

The present invention relates to a method of forwarding messages over a network. The message forwarding method is implemented in a router (101a to 101 g) of a distributed network (100) comprising, at the level of the OSI layer 7, at least one sub network (102a to 102c) being constrained, the method comprising at least the following steps:
processing a unique format for the whole set of messages;
for a given message, identifying the next routers (101a to 101g) to be reached in order to forward the message to its recipient or recipients;
for a given message, identifying the transmission service quality;
assigning priorities to the messages as a function of the service quality requirements identified in the previous step;
adapting the content of the message so as to pass through a constrained sub-network (102a to 102c).

The method notably applies to exchanges of messages on networks constituted by heterogeneous sub networks.

The present invention relates to a method of forwarding messages over a network and a router for implementing the method. The method notably applies to exchanges of messages over networks constituted of heterogeneous sub-networks

In order to meet the increasing needs for data exchanges between data processing applications whilst being based on one and the same hardware and logic structure, systems making it possible to process unified message streams have been created. These systems, often called ESB (Enterprise Service Bus) systems, allow heterogeneous applications to communicate, these applications being, for example, messaging tools, Service Oriented Architecture (SOA) applications, or data dissemination software. ESBs are well suited for installation on local networks using the Internet Protocol (IP), these networks offering a large bandwidth. However, when these applications are interconnected via one or more sub-networks that are constrained—notably in terms of data rate capability—undesirable effects can arise, such as message losses or unacceptable transmission times.

Moreover, certain tools take account of the constraining nature of certain sub-networks. By way of example, messaging tools have been developed for the purpose of optimizing the transmission of emails over radio-communication networks. However, these tools are special applications developed in order to respond to specific needs; they are not provided for conveying messages coming from multiple applications.

In addition to the problems of heterogeneity at the level of the capacities of the sub-networks, a message forwarding system must, if possible, make it possible to adapt to topology changes in the network and/or to determine transmission routes dynamically as a function of the recipients of a message.

Finally, the operating conditions of the network sometimes necessitate having to adapt to the mobility of the applications and nodes of the network.

A purpose of the invention is to propose a message router able to serve as a node within a network comprising one or more constrained sub-networks, said router making it possible for these heterogeneous applications connected to the network to be able to transmit and/or receive messages, through a unique interface, whilst taking account of the service quality to be provided in the forwarding of a message. For this purpose, the invention relates to a method of forwarding messages implemented in a router of a distributed network comprising one or more heterogeneous sub-networks, said method being implemented at the level of the OSI layer 7, characterized in that at least one sub-network is constrained, the method comprising at least the following steps:
processing a unique format for the whole set of messages in order to unify the message streams coming from heterogeneous applications;
for a given message, identifying the next routers to be reached in order to forward the message to its recipient or recipients;
for a given message, identifying the transmission service quality required for the message via the analysis of the content of said message;
assigning priorities to the messages as a function of the service quality requirements identified in the previous step;
adapting the content of the message so as to pass through a constrained sub-network, these adaptations being determined as a function of the capacities of the constrained sub-network and of the content of the message.

According to one embodiment, at least one constrained sub-network is a radio-communications sub network.

The recipient of a message can be marked as optional via a specific field of the addressing protocol, an optional recipient being served if it is connected to one of the message routers chosen for forwarding the message to its non-optional recipients.

According to one embodiment, a message is formatted according to the SOAP standard, the addressing format used in the message being an extension of the WS-addressing standard making it possible to specify several recipients of the message, said extension being carried out by adding a specific field in the header of the message.

The invention also relates to a message router within a network interconnecting one or more constrained sub-networks, the router comprising a forwarding module executing the steps of the method as described above, the forwarding module interacting with a LOC module in order to identify the next routers to reach.

According to one embodiment, the message router records one or more distribution groups in the LOC module, a distribution group grouping several identifiers of simple recipients or distribution groups, a distribution group being specified as a recipient of a message in the same way as a simple recipient.

According to one embodiment, the message router comprises a signaling module reserving resources on sub-networks for applications wishing to establish distribution sessions with particular service quality requirements, the forwarding module interacting with the signaling module in order to establish the transfer priorities of the messages.

According to one embodiment, the message router comprises at least the following three interfaces:
a first affiliation interface IAFF allows an application to request to register its location with the network;
a second interface IRES allows a source to establish a session in order to transmit a message flow requiring a particular service quality;
a third interface IMSG allows a source to deposit a message to be distributed to recipients specified in the message.

The invention also relates to a system for the distribution of messages between a source and one or more recipients connected to a distributed network comprising one or more constrained sub-networks, comprising several message routers such as described above, the messages being transmitted in hops from one message router to another, the distribution tree of a message being established hop by hop in order to adapt to topology changes in the network.

According to one embodiment of the message distribution system, at least one constrained sub network is included between at least two transfer gateways, a first transfer gateway processing the messages transmitted between a first message router and a constrained sub network, a second transfer gateway processing the messages transmitted between a second message router and said constrained sub-network, each gateway adapting a message, coming from or going to the router to which it is connected, to the specific protocol of the constrained sub network.

Other features will appear on reading the following detailed description, given by way of non limitative example and with reference to the appended drawings in which:

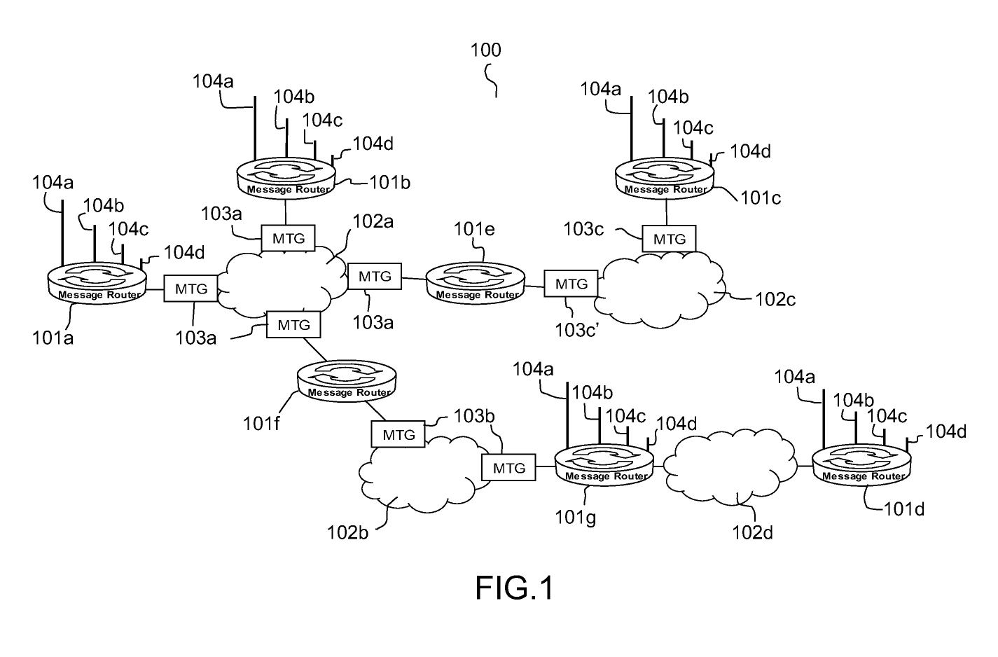

FIG. 1 shows a network comprising routers implementing the method according to the invention,

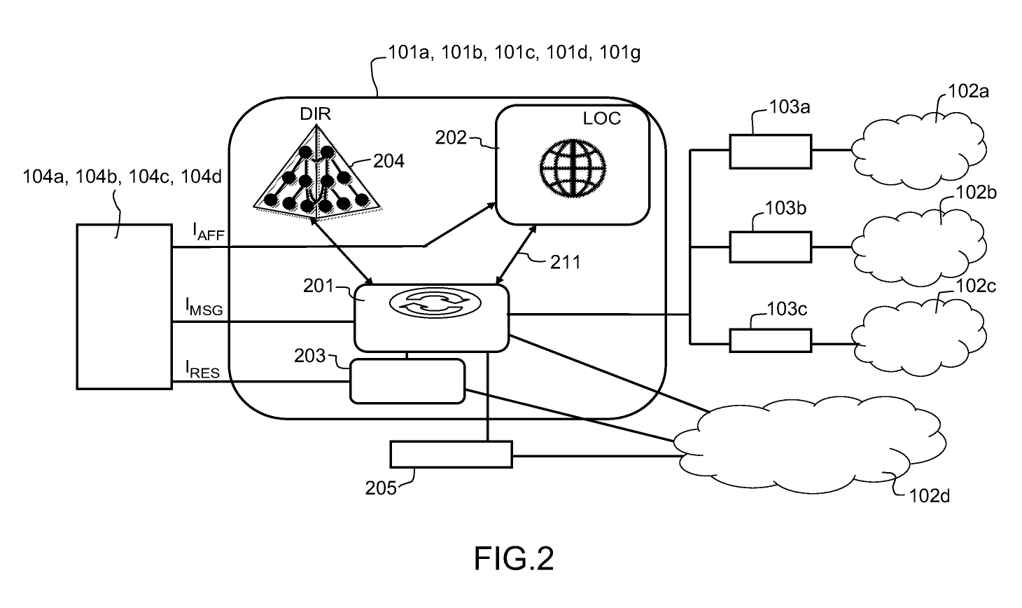

FIG. 2 shows an example of an embodiment of a message router according to the invention.

FIG. 1 shows a network comprising several message routers implementing the method according to the invention. The network 100 is formed of message routers 101 interconnecting sub-networks 102a, 102b, 102c, 102d. The sub-networks are, for example, heterogeneous sub-networks. The method according to the invention is implemented at the level of the OSI layer 7. The term “message” refers, in the present application, to level 7.

In the example of FIG. 1, each sub-network 102a, 102b, 102c, 102d is of different nature. Three sub networks 102a, 102b, 102c are radio-communication networks operating in different frequency bands. The first sub-networks 102a occupies a portion of the UHF (Ultra High Frequency) band, the second network 102b occupies the VHF (Very High Frequency) band and the third network 102c is an HF (High Frequency) network. A fourth sub-network 102d is a local high data rate network operating on the Internet Protocol (IP). Each of these sub-networks 102a, 102b, 102c, 102d therefore has unequal capacities.

A message router is, according to its disposition within the network 100, either a transit node between several sub-networks, or an access point to the network 100 for user applications, or both at once. In the example, four routers 101a, 101b, 101c, 101d are points of access to the network 100, two routers 101e, 101f are transit nodes, and one router 101g is both an access point to the network 100 and a transit node. More precisely, the first router 101a and the second router 101b are access points to the first sub-network 102a, the third router 101c is an access point to the third sub-network 102c, the fourth router 101d is an access point to the fourth sub-network 102d. The fifth router 101e is a transmit node between the first sub network 102a and the third sub-network 102c and the sixth router 101f is a transit node between the first sub-network 102a and the second sub-network 102b. Finally, the seventh router 101g is both a transit node between the second sub-network 102b and the fourth sub network 102d and an access point to the network 100.

The routers 101a, 101b, 101c, 101d, 101g serving as access points to the network 100 can notably be connected to the following applications 104a, 104b, 104c, 104d:
data dissemination grids 104a, these connecting data producers with data consumers;
SOA (Service Oriented Architecture) applications 104b, these applications when deployed around constrained networks therefore having to benefit from a high-performance message distribution system;
existing applications 104c, such as messaging, instantaneous messaging, file transfer, these applications generally being denoted by the term “legacy”.
replication applications 104d (for example for the replication of databases) and/or signaling applications (for example for transmitting updating information on the connection/disconnection of stations connected to the network 100).

The abovementioned applications, of heterogeneous nature, are, for the network 100, sources and/or recipients of messages, said messages being produced in a unique format. The unification of the message streams is notably obtained by the choice of an exchange protocol facilitating interoperability between different applications. In the example, the messages comply with an exchange protocol based on Web Services, and more particularly on the SOAP (Simple Object Access Protocol) standard. An advantage of the router according to the invention is that it processes messages at application level, which notably makes it possible to apply a quality policy as a function of the nature of the transported messages.

Moreover, the transfer gateways 103a, 103b, 103c are respectively disposed around each constrained sub network 102a, 102b, 102c, in such a way as to allow the adaptation of the messages to the specific protocols of these constrained sub-networks 102a, 102b, 102c. These gateways are disposed in pairs, a first gateway being disposed for processing messages entering a sub-network, a second gateway being disposed for processing messages leaving this same sub-network, the gateways each alternately assuming the role of an incoming gateway or an outgoing gateway according to the direction of message forwarding. For example, a gateway 103c processing an incoming message for the sub network 102a, 102b, 102c, adapts said message to said sub-network (for example fragments the message, receives acknowledgements, manages the re transmissions) and the dual gateway 103c′, that is to say the gateway processing this outgoing message from the sub-network, applies the dual operation (in this case reconstitutes the message from fragments formed by the preceding gateway 103c and manages the sending of acknowledgements). It should be noted, in the example of FIG. 1, that no gateway is placed between the message routers 101d, 101g and the high data rate IP fourth sub-network 102d. In fact, as the IP transport protocol used on these sub-networks 102d are native to SOAP, it is not necessary to adapt the message in order to transmit it to this sub-network 102d.

FIG. 2 shows an example of an embodiment of a message router according to the invention. The router 101a to 101f according to the invention comprises three interfaces with the application level.

A first interface IAFF allows an application to request to register its location with the network 100 or to join a distribution group, this distribution group concept being described in detail below. In fact, the router 101a to 101g provides the possibility of addressing a message to a distribution group, that is to say to several recipients grouped under a single identifier. An affiliation request generated by an application connected to the message router 101a, 101b, 101c, 101d, 101g is carried out by specifying the identifier of said application, in the example, using the WS-addressing standard. Affiliation is not carried out for message routers that are simple transit nodes, like the fifth 101e and sixth 101f message routers.

A second interface IRES allows a source to establish a session for transmitting or receiving a message stream requiring a particular service quality, for example in terms of latency—in this case, the request for reservation of resources is formulated by the recipient application—or the data rate—in this case, the request for reservation of resources is formulated by the transmitting application. In the example, this session is then used for transmitting a stream of SOAP messages. In order to propagate the service quality requirements of the session to the subjacent layers of the OSI (Open Systems Interconnection) model, a resources reservation protocol such as RSVP (Resource ReSerVation Protocol) can then be implemented.

A third interface IMSG allows a source to deposit a message to be distributed to one or more recipients specified in the message. The addressing to several recipients is carried out by means of an extension of the WS-addressing standard: a field is added into the header of the SOAP message. The nature of a recipient—obligatory or optional—can be specified, while an identifier can designate a distribution group. A recipient qualified as optional is served, if it can be, from the distribution tree determined for serving the obligatory recipients of the message. The optional or obligatory nature of a recipient is, in the example, specified in a specific field of the addressing protocol. By way of example, a source connected to the first router 101a transmits a message whose recipients are as follows: one obligatory recipient connected to the fourth router 101d, one optional recipient connected to the third router 101c, and another optional recipient connected to the seventh router 101g. The distribution tree of the message is determined for forwarding the message to the single obligatory recipient, which is connected to the fourth router 101d. The path followed by the message will therefore include the following routers respectively: the first router 101a, the sixth router 101f, the seventh router 101g and the fourth router 101d. Among the optional recipients, only the one connected to the seventh router 101g it therefore served. It should be noted that an optional recipient can moreover be a distribution group.

The router comprises a forwarding module 201, a locating and routing module 202, a signaling module 203 and a technical directory 204.

The locating and routing module 202, hereafter referred to as the “LOC module” 202, generates the distribution tree of a message notably taking account of the location of the recipients of the message, of the instantaneous topology of the network 100 and of the sub-networks 102a to 102d, and of the capacities of these sub-networks. The LOC module 202 can, for example, be the LOC module described in the patent referenced FR2878676 by the applicant, Thales, one of the advantages of this LOC module being that it makes it possible to adapt to the network topology changes by means of an updating of its location and routing tables. The LOC module 202 also makes it possible to manage distribution groups, each of said groups being, for example, recognized by an identifier of the URI (Uniform Resource Identifier) type. This particular URI is defined in a database of the LOC module 202 and corresponding to several URIs of simple destinations or of groups.

The LOC module 202 is updated among other things by means of location affiliation messages transmitted by the local user applications of the network 100 and received, in the example, by the first affiliation interface IAFF, these messages informing the LOC module 202:
of the attachment/detachment of applications to this message router in order that the LOC module 202 can construct the instantaneous topology of the network 100 (by combining its local knowledge with the knowledge it has from other LOC modules deployed in the network);
of the presence or not of destinations referenced in the distribution groups in order to update its distributed database defining said distribution groups.

The signaling module 203 reserves resources on sub networks 102a to 102d for applications wishing to establish distribution sessions having particular service quality requirements, for example a guaranteed latency time and/or data rate, or control of the variation of the latency time.

The technical directory 204 provides the information necessary for the administration of the message router 101a to 101g. This information is, for example, configuration data defining the service quality policy of the message router 101a to 101g or the identifiers of the applications authorized to use the services of the message router 101a to 101g.

When a message is received by a message router 101a to 101g, the forwarding module 201 requests the LOC module 202 to identify the next router or routers 101a to 101g to reach, in other words the next hop or hops making it possible to forward the message to its recipient or recipients. If these recipients are local, that is to say connected to the current message router, the message is transmitted directly to the applications in question, for example a messaging server or a data dissemination intermediary. If, on the contrary, these recipients are remote, the forwarding module 201 produces, for each next hop, a copy of the message. In each of these copies, it mentions the obligatory recipients which must be served by this next hop and the optional recipients potentially reachable by that hop. The interactions between the forwarding module 201 and the LOC module 202 are represented by a double headed arrow 211 in FIG. 2. The hop-by-hop routing is carried out in level 7.

The message distribution tree a thus established hop by hop, and not at one single time. This feature makes it possible to adapt the distribution tree dynamically to topology changes in the network 100 and to facilitate the management of optional recipients.

When the next hop transmits a message to a sub network not having IP capability, the LOC module 202 specifies the addresses of this sub-network to be used for distributing the message. In the case of transfer on a constrained network, the forwarding module 201:
(i) compresses the content of the message if necessary,
(ii) checks if certain attached items must be withdrawn, the withdrawal decision being made, for example, as a function of the size of said attached items,
(iii) transfers the message with its parameters (notably the address of the output transfer gateway) to an MTG transfer gateway, which manages the addressing and the adaptations to the specific protocol of the constrained sub network.

In the case of transfer of the message on a sub network having multi-point, or “multicast” connection capabilities, the forwarding module 201 entrusts the message to a gateway module 205 capable of managing a transfer protocol, with or without acknowledgement, to the recipients.

In the example, when an application requests the distribution of a message to a group via the IMSG interface, the forwarding module 201 requests the LOC module 202 to identify the recipients corresponding to that group identifier. According to another embodiment, the group identifier is not resolved and the message is transmitted to the next message routers whilst retaining that group identifier.

The forwarding module 201 implements management of the service quality in the distribution of messages.

On the one hand, the forwarding module 201 manages, for the same next hop, sessions that differ according to the priority of the messages. Thus, the module 201:
marks the packets of a same message in a univocal manner, so that these packets have a transfer priority corresponding to the characteristics of the message,
transfers the urgent messages without having to wait for the transfer of messages that are less urgent and/or of large size.

On the other hand, the forwarding module 201 allows the transmission of message streams in a session previously initialized by the signaling module 203, resources having been reserved on the sub networks to be passed through for that session. The module thus makes it possible to comply with the desired latency time and/or data rates in the transfer of the messages of a session.

The router according to the invention has many advantages, notably due to the hop-by-hop construction of the distribution tree of a message. It makes it possible to manage optional recipients simply, to adapt to the mobility of the applications connected to the network, to assume responsibility for the management of groups of recipients, to transmit unified multi-point data flows and for all this to take place over a network which can comprise one or more constrained sub networks.

The present invention identifies the service quality and assigns priorities at level 7 independently from the QoS service quality services offered by the subjacent layers. Depending on the capacities of the networks, which are heterogeneous, the invention is capable of exploiting the QoS functions available on these networks.

1. A method of forwarding messages implemented in a router of a distributed network, said network including one or more heterogeneous sub-networks of which at least one sub-network is constrained, said method implemented at the level of the OSI layer 7 and comprising at least the following steps:
processing a unique format for the whole set of messages in order to unify the message streams coming from heterogeneous applications;
for a given message, identifying the next routers to be reached in order to forward the message to its recipient or recipients;
for a given message, identifying the transmission service quality required for the message via the analysis of the content of said message;
assigning priorities to the messages as a function of the service quality requirements identified in the previous step;
adapting the content of the message so as to pass through a constrained sub-network, these adaptations being determined as a function of the capacities of the constrained sub-network and of the content of the message.

2. The forwarding method as claimed in claim 1, wherein at least one constrained sub network is a radio-communications sub network.

3. The forwarding method as claimed in claim 1, wherein a recipient of a message is marked as optional via a specific field of the addressing protocol, an optional recipient being served if it is connected to one of the message routers chosen for forwarding the message to its non-optional recipients.

4. The forwarding method as claimed in claim 1, wherein a message is formatted according to the SOAP standard, the addressing format used in the message being an extension of the “WS-addressing” standard making it possible to specify several recipients of the message, said extension being carried out by adding a specific field in the header of the message.

5. A message router within a network interconnecting one or more constrained sub-networks, wherein the router comprises a forwarding module executing the steps of the method as claimed in claim 1, the forwarding module interacting with a LOC module in order to identify the next routers to reach.

6. The message router as claimed in claim 5, wherein it records one or more distribution groups in the LOC module, a distribution group grouping several identifiers of simple recipients or distribution groups, a distribution group being specified as a recipient of a message in the same way as a simple recipient.

7. The message router as claimed in claim 5, wherein it comprises a signaling module reserving resources on sub-networks for applications wishing to establish distribution sessions with particular service quality requirements, the forwarding module interacting with the signaling module in order to establish the transfer priorities of the messages.

8. The message router as claimed in claim 5, further comprising at least the following three interfaces:
a first affiliation interface IAFF allows an application to request to register its location with the network;
a second interface IRES allows a source to establish a session in order to transmit a message flow requiring a particular service quality;
a third interface IMSG allows a source to deposit a message to be distributed to recipients specified in the message.

9. A system for the distribution of messages between a source and one or more recipients connected to a distributed network, said network including one or more constrained sub-networks, said system including several message routers as claimed in claim 5 the messages being transmitted in hops from one message router to another, the distribution tree of a message being established hop by hop in order to adapt to topology changes in the network.

10. The message distribution system as claimed in claim 9, wherein at least one constrained sub network is included between at least two transfer gateways, a first transfer gateway processing the messages transmitted between a first message router and a constrained sub network, a second transfer gateway processing the messages transmitted between a second message router and said constrained sub-network, each gateway adapting a message, coming from or going to the router to which it is connected, to the specific protocol of the constrained sub network.
